(19) United States
(12) Patent Application Publication
(10) Pub. No.: US 2012/0147034 A1
(43) Pub. Date: Jun. 14, 2012

(54) ANIMATED LINK SENSATION

(75) Inventor: Thomas Binzinger, Geilenkirchen (DE)

(73) Assignee: area800 S.A., Luxembourg (LU)

(21) Appl. No.: 13/251,386

(22) Filed: Oct. 3, 2011

Related U.S. Application Data
(60) Provisional application No. 61/389,292, filed on Oct. 4, 2010.

(51) Int. Cl. G06T 13/00; G09G 5/377

(52) U.S. Cl. 345/629

(57) ABSTRACT

The present invention relates to a system and method which enable to present an orientation aid to users watching pages on a electronic computation output device, like a computer screen, a TV or a smart- or cell phone screen and receive automatically or on demand animated visual aid where to interact with the device through touching the screen or moving a electronic pointer over the area. This computer implemented method is designed to act as an additional layer of queries over traditional acknowledgeable area where to interact with a electronic page, like a website, in cases there the coding of these interactive areas is not possible in the underlying page itself, like but not limited to pdf or jpg files formats and alike.

The present invention refers to a system and method to animate interactive areas on a computer output systems where the displayed page or content on the said computer output system can not be coded in a way that the areas which a user can touch or move a pointer over can be identified easy therefore the invention provides a system and a method where the area in the displayed page will be animated so that the user gets an information, like but not limited to a visual animation or a sound played, that lets him know that and where he can interact with the device, like but not limited to touching the screen surface or clicking on a mouse while hovering the mouse pointer over the animated area.

In today's computerized world it is normal for users of any computerized system like but not limited to a computer itself, a cell phone, a smart phone, a tablet computer device or even a remote control for TVs or a navigation system for cars, that he can identify areas at the different screens in all different sizes where he can interact with the system to initiate an input which will manipulate the underlying software system of the computerized system to computate one or more steps and produce an output depending on the type of input. To help the user identifying the areas on the output devices of the different computation devices the engineers typically build some interactive pages using a programming language to mark the area where users can interact with the device.

The interactive parts and areas are typically coded in the page itself using programming language like but not limited to Basic, C, C++ or even mostly HTML. The areas where users can interact with the screen, also known as links, are typically marked, where as areas within text typically are color coded or underlined or bold or a combination of this. If the area where users can interact with the page is a picture or a graphics within the page it is typically coded in a way that the user can move an pointer by using an additional input device, like but not limited to a computer mouse, a light pointer or a finger over the picture or graphic with the programmed effect that the pointer itself changes in shape or color to identify interactive areas.

This method is widely used and implemented into almost any computable system in the world. Although with modern devices like but not limited to the iPhone, iPad or Android and other devices with touch screens where the user interact without an additional device like a mouse with the software program in touching the screen of the device this method described above reaches it's limitations because touching the screen does typically initiate an action of the application and that is the action itself and not the animation of the interactive area. Therefore animated visual aids are typically not available in certain applications.

This is true especially but not limited to situations that the underlying page is not coded into different areas or has no text, pictures, graphics embedded into the code but consists of ONE full size picture or file format where the engineer can not code any areas or animation into the underlying page. Today there is no integrated system or method to let the user know where he can interact with the system. The engineer might need to inform the user utilizing a non-integrated system, like but not limited to a printed instruction on paper or a split screen, where one part of the screen shows the page and the other displays the instruction.

The invention is a method to program an overlay on top of the underlying page and identify and code in this overlay areas where the user can interact with the computation device and the engineer can move any shape like but not limited to a square, a rectangle, a circle or any other geometrical or non-geometrical shape to a certain location and define the area as interact able link like but not limited to touching the screen.

The method allows the engineer also to define which kind of input is allowed, like but not limited to touching, tipping, swiping, tipping with two fingers, tipping with a pen or any other gesture or movement.

The method allows the engineer also to define the determined output on the computing machine like but not limited to displaying of a message, a sound, a video, changing to another page.

The method allows the engineer also to define the kind of animation which is displayed on top of the underlying page like but not limited to color change, highlighting, blinking or any other change in shape form or size which is independent from the coding of the underlying page.

The system and method invented here is enabling the engineer to code a overlay structure on top of any other underlying page, which is coded in parts or just displaying one part, like but not limited to a picture or graphics, so that the overlay structures displays animated shapes to the user, registers any input on these shapes from the user and hands these information over to a second program, like but not limited to the operation system of the device or a coded software program running on the device to performs defined task based on the input of the user.

Another part of the invention is a method to identify the interactive part of the underlying page on an output system of a computable system like but not limited to a computer itself, a cell phone, a smart phone, a tablet computer device or even a remote control for TVs or a navigation system for cars at the moment that the users is accessing the page. To inform the user about “hidden” information on a page the method and system is showing an animated sequence like a beacon at the location on the page when the user accesses the page.

The animation, which can come in any shape, form and size, can be displayed based on defined parameters in length and frequency. User can turn on the animation on demand that then will be displayed again in the same way or in a different way.

The system and method is intended to be very useful for, but not limited to, any computing device which has a touch screen and is displaying pages where the pages are not coded in individual parts but as one content part like but not limited to a pdf or a jpg file format, specifically but not limited to displaying magazine pages or whole magazines where the user is reading the magazine on such a device like but not limited to the iPhone, iPad or Android phones or tablets and other devices with touch screens and the publisher of such magazines has used pdf file format coded pages to create the magazine app for this device but has also added additional content, like but not limited to additional software programs, pages, sounds, videos or internal or external links to pages or the interne itself and where the user would not know where to interact with the magazine.

In addition to the problem that the user would not know where he can interact with the page the user might coincidentally touch or click an area where other commands will be performed, like but not limited to, turning the page to the next page. In this case the user will not be able to identify the area with added content or additional links but will leave the page before he could see the message which the publisher intended him to see, like but not limited to a video played in combination with an advertisement.

In another embodiment the system and method is used to generate animated spots which are controlled by the system itself in a way that the animation is displayed based on specific input from the user, like but not limited to an answer to a question or the length of time between displaying the information and the users input. By way of example if an interactive are is questioning the age of the user and the user chooses form a menu, which can be programmed by using this invention, but can also be coded by any other computer programming language or method, the age of “under 10 years” versus “older than 10 years”, the animation can be changed like but not limited to, displaying little ducks for the “under 10” spectator to a superhero shape for the “older than 10 years” user or to any other shape not limited in size or form or method of different output.

What is claimed is:

1) a system to code an overlay structure on top of any other underlying electronic displayed page, which is coded in parts or just displaying one part, like but not limited to a picture or graphics, so that the overlay structures displays animated shapes to the user, registers any input on these shapes from the user and hands these information over to a second program, like but not limited to the operation system of the device or a coded software program running on the device to performs defined task based on the input of the user.

2) where the system described in 1 is used to generate animated spots which are controlled by the system itself in a way that the animation is displayed based on specific input from the user, like but not limited to an answer to a question or the length of time between displaying the information and the users input.

3) a method to code an overlay structure on top of any other underlying electronic displayed page, which is coded in parts or just displaying one part, like but not limited to a picture or graphics, so that the overlay structures displays animated shapes to the user, registers any input on these shapes from the user and hands these information over to a second program, like but not limited to the operation system of the device or a coded software program running on the device to performs defined task based on the input of the user.

4) where the method described in 2 is used to generate animated spots which are controlled by the system itself in a way that the animation is displayed based on specific input from the user, like but not limited to an answer to a question or the length of time between displaying the information and the users input.
